(19) United States
(12) Patent Application Publication
(10) Pub. No.: US 2018/0363349 A1
(43) Pub. Date: Dec. 20, 2018

(54) OPENING AND CLOSING DEVICE FOR OPENING AND CLOSING BODY, AND VARIOUS OPENED AND CLOSED BODIES HAVING THE SAME

(71) Applicant: KEM HONGKONG LIMITED, Kowloon (HK)

(72) Inventor: Ryuta Kuramochi, Kanagawa (JP)

(21) Appl. No.: 16/008,600

(22) Filed: Jun. 14, 2018

(30) Foreign Application Priority Data
Jun. 20, 2017 (JP) 2017-120800

(51) Int. Cl. E05F 3/10; E05F 3/22; E05F 3/16; E05F 1/08

(52) U.S. Cl. CPC E05F 3/104; E05F 3/221; E05Y 2201/256; E05F 1/08; E05Y 2201/21; E05F 3/16

(57) ABSTRACT

To provide an opening and closing device for opening and closing body having a rotation torque controlling module and a torque peak adjusting module, solution was sought by an opened and closed body and the opening and closing body which comprises an attaching part, an opening and closing part rotatably attached to the attaching part via a hinge shaft, a rotation torque controlling module for controlling a rotation torque of the opening and closing part, a torque peak adjusting module for adjusting a torque peak of the opening and closing part at the time of its opening and closing movement.

### FIELD OF THE INVENTION

The invention relates to an opening and closing device for opening and closing body, wherein the opening and closing body includes a door body and a document cover, and it is attached to an opened and closed body such as various sorts of cabinets, copying machines and printers, so as to be openable and closable in upward and downward direction; as well as to various opened and closed bodies, each having such an opening and closing device for opening and closing body.

### BACKGROUND ART

Conventionally, it is in general preferable for an opening and closing device for opening and closing body to have a function to enable the opening and closing body to stably stop and maintain its state, in which it is opened upward relative to any of various opened and closed bodies. As conventional opening and closing device for opening and closing body, the one described in Re-Publication of PCT International Application in Japan No. 2011-129154 is known. The opening and closing device for opening and closing body described in Re-Publication of PCT International Application in Japan No. 2011-129154 is attached to both inner lateral surfaces, and draws out arms or stays of its interior to support the opening and closing body. Many other opening and closing devices for opening and closing body of this sort have a similar structure.

The opening and closing device for opening and closing body described in Re-Publication of PCT International Application in Japan No. 2011-129154 has a problem that the opening and closing device itself protrudes from both sides of an opened and closed body, and that it has an arm and a stay which are extended and retracted when the opened and closed body is opened and closed, so that such elements are a hindrance to stored goods in the opened and closed body, wherein the goods are stored and taken out; further there is another problem that the opening and closing device does not have an adequate function to stably stop and hold the opening and closing body at a predetermined opening angle of the opening and closing body. Furthermore, the opening and closing device has redundant components, such as an additional elastic member which is used as buffering means for mitigating an impact at the time of closing the opened and closed body. Still further, the one comprising an opening and closing torque controlling means of the opened and closed body is known according to JP Laid-Open Patent Application No. 2009-58790, but it is not provided with torque peak adjusting means.

Therefore, to solve the above-mentioned problem, the Applicant proposed an opening and closing device for opening and closing body provided between an opened and closed body and the opening and closing body for openably and closably coupling the opening and closing body to the opened and closed body, wherein the opening and closing device comprises an external bracket having at least a back plate portion and both side plate portions bent from the back plate portion, wherein the external bracket is attached to the opened and closed body; an opening and closing member having at least a back plate portion to which the opening and closing body is attached and both side plate portions bent from the back plate portion, wherein the both side plate portions are rotatably attached to the both side plate portions of the external bracket via a hinge shaft, a pressure receiving member attached to a position for rotating with the hinge shaft as a fulcrum between the both side plate portions of the opening and closing member, a cam slider in contact with the pressure receiving member, wherein it is provided so as to be slidable in the external bracket, an urging means provided in the external bracket for pressurizing the cam slider toward the pressure receiving member, an engaging means for releasably engaging with an engaging portion provided on the cam slider, depending on a slide position of the cam slider which varies depending on a rotation angle of the opening and closing member as accompanied with an opening and closing movement of the opening and closing body, and an elastic force adjusting means for adjusting an elastic force of the urging means; additionally, the Applicant also proposed various opened and closed bodies comprising such an opening and closing device (JP Patent Application No. 2016-213435).

The opening and closing device for opening and closing body according to this earlier application does adjust a rotation torque of the opening and closing member using the elastic force adjusting means, but does not have a structure for enabling the device to adjust a torque peak of the opening and closing member. Needs to optionally change a torque peak of the opening and closing member within a predetermined range are fully recognized, mainly in terms of convenience and versatility. Still further, it is also a technical problem to enhance a function of stably holding the opening and closing body at a closed state at 0 degree and at a fully opened state relative to the opened and closed body, with no use of stay and arm.

### SUMMARY OF THE INVENTION

Therefore, it is an object of the invention to provide an opening and closing device for opening and closing body for attaching an opening and closing body to an opened and closed body, such that the former can open and close relative to the latter, wherein the opening and closing device is further featured with a function of changing a torque peak of the opening and closing member and of stably holding the opening and closing body, as well as various opened and closed bodies comprising such an opening and closing device for opening and closing body.

To achieve the above-mentioned object, the invention according to the first aspect of the invention is characterized in that an opening and closing device for opening and closing body provided between an opened and closed body and the opening and closing body for coupling the opening and closing body to the opened and closed body so as to be openable and closable in upward and downward direction comprises an attaching member having at least a back plate and both side plates bent from the back plate and attached to the opened and closed body; an opening and closing member having at least an attaching plate to which the opening and closing body is attached and both side plates bent from the attaching plate, wherein the opening and closing member is rotatably attached to the attaching member via a hinge shaft; a rotation torque controlling means for controlling a rotation torque of the opening and closing member, a torque peak adjusting means for adjusting a torque peak of the opening and closing member at the time of its opening and closing movement; that the rotation torque controlling means comprises a rotation member attached to the hinge shaft in order to rotate together with the opening and closing member, and a slider provided on the attaching member side and slidably urged by an elastic member toward the rotation member; and that the torque peak adjusting means comprises a link arm, wherein its one end is coupled to the slider side via a second link shaft, and its other end is rotatably attached to the opening and closing member side via a first link shaft rotatably attached with a coupling position on the slider side as a fulcrum, and a position adjusting means provided on the opening and closing member side and capable of adjusting a rotation starting position of the link arm.

Still further, the invention according to the second aspect of the invention is characterized in that a rotation torque controlling means comprises a locking means capable of locking an opening and closing body at a predetermined opening and closing angle, and that the locking means comprises a rotation member attached to a hinge shaft so as to be rotatable together with the opening and closing member, and a locking member slidably provided on an attaching member side so as to be slidable to a rotation member side and to engage with locking concave portions provided on a rotation member at a predetermined rotation angle of the opening and closing member.

Still further, the invention according to the third aspect of the invention is characterized in that a rotation torque controlling means comprises on a slider side a rotation torque adjusting means capable of adjusting a rotation torque of an opening and closing member.

Still further, the invention according to the fourth aspect of the invention is characterized in that a buffering means is provided between a slider and a rotation member, wherein it consists of a fluid damper for bringing a tip of a piston rod into a pressurized contact with a cam portion provided on the rotation member, starting from a predetermined rotation angle of an opening and closing member in a closing direction.

Still further, the invention according to the fifth aspect of the invention is characterized in that a position adjusting means of a torque peak adjusting means comprises a first link member, wherein its one end is attached so as to be slidable in forward and backward direction relative to an opening and closing member and its other end coupled to a second link shaft, a second link member, wherein its one end is coupled to the second link shaft and its other end coupled to a hinge shaft, and an adjusting member attached to the opening and closing member and screwed with the first link member.

Still further, the invention according to the sixth aspect of the invention is characterized in that it is various opened and closed bodies comprising an opening and closing device for opening and closing body as described above.

Since the invention is constructed as described in the foregoing, an opening and closing device for opening and closing body does not project into an opened and closed body, so that it is not a hindrance to stored goods which go inside and come out of the opened and closed body, and that at the time of an opening and closing operation, a rotation torque controlling means makes it possible to smoothly open the opening and closing body without giving a feel of its own weight; still further, the invention prevents the opening and closing body from suddenly falling during its closing operation to ensure an enhanced operability, and if it uses a locking means, it enables to maintain a stable holding state at the closed and fully opened state, and if it uses a fluid damper, it enables to absorb a shock in order to prevent the opening and closing body from suddenly falling from its predetermined closing angle for closing. Still further, if it uses an elastic force adjusting means, it enables to adjust an opening and closing torque of an opened and closed body, and if it uses a torque peak adjusting means, it enables to adjust a torque peak of an opening and closing member, so that it is possible to provide a more convenient opening and closing device for opening and closing body.

### BRIEF DESCRIPTION OF THE DRAWINGS

FIG. 1 shows a perspective view of an opening and closing device for opening and closing body according to the invention;

FIG. 2 shows a plan view of an opening and closing device for opening and closing body according to the invention;

FIG. 3 shows an exploded perspective view of an opening and closing device for opening and closing body according to the invention;

FIG. 4 shows a perspective view of an attaching member of an opening and closing device for opening and closing body according to the invention, as is seen from below;

FIGS. 5A and 5B show a spring holder of an opening and closing device for opening and closing body according to the invention, FIG. 5A being its perspective view, as is seen from backward, and FIG. 5B—its cross section illustrating its interior structure;

FIGS. 6A to 6C show a slider of an opening and closing device for opening and closing body according to the invention, FIG. 6A being its perspective view, as is seen from backward, FIG. 6B—its perspective view, as is seen from below, and FIG. 6C—its cross section illustrating its interior structure;

FIGS. 7A to 7C show a rotation member of an opening and closing device for opening and closing body according to the invention, FIG. 7A being its perspective view, as is seen from front, FIG. 7B—its perspective view, as is seen from backward, FIG. 7C—a longitudinal section of its central portion;

FIG. 8 shows an enlarged perspective view of a part of a torque peak adjusting means of an opening and closing device for opening and closing body according to the invention;

FIG. 9 shows an exploded perspective view of a part of a torque peak adjusting means of an opening and closing device for opening and closing body according to the invention;

FIGS. 10A and 10B show a first member of a part of a torque peak adjusting means of an opening and closing device for opening and closing body according to the invention, FIG. 10A being its perspective view, and FIG. 10B—its plan view;

FIGS. 11A and 11B show an adjusting member of a part of a torque peak adjusting means of an opening and closing device for opening and closing body according to the invention, FIG. 11A being its perspective view, and FIG. 11B—its plan view;

FIGS. 12A to 12C illustrate operation of an opening and closing device for opening and closing body according to the invention, at an opening and closing angle of 0 degree, at which an opening and closing body is closed relative to an opened and closed body, FIG. 12A showing an area of main elastic members, FIG. 12B—an area of a fluid damper, and FIG. 12C—an area of a link arm;

FIGS. 13A to 13C illustrate operation of an opening and closing device for opening and closing body according to the invention, showing a state in which an opening and closing body is opened 30 degrees relative to an opened and closed body from a state shown in FIG. 12, FIG. 13A showing an area of main elastic members, FIG. 13B—an area of a fluid damper, and FIG. 13C—an area of a link arm;

FIGS. 14A to 14C illustrate operation of an opening and closing device for opening and closing body according to the invention, showing a state in which an opening and closing body is opened 60 degrees relative to an opened and closed body from a state shown in FIG. 12, FIG. 14A showing an area of main elastic members, FIG. 14B—an area of a fluid damper, and FIG. 14C—an area of a link arm;

FIGS. 15A to 15C illustrate operation of an opening and closing device for opening and closing body according to the invention, showing a state in which an opening and closing body is opened 100 degrees relative to an opened and closed body from a state shown in FIG. 12, FIG. 15A showing an area of a main elastic member, FIG. 15B—an area of a fluid damper, and FIG. 15C—an area of a link arm;

FIGS. 16A to 16C illustrate operation of a torque peak adjusting means of an opening and closing device for opening and closing body according to the invention, FIG. 16A showing its state at a torque peak adjusting angle of 0 degree, FIG. 16B—its state at a torque peak adjusting angle adjusted to +10 degree, and FIG. 16C—its state at a torque peak adjusting angle adjusted to −10 degree; and

FIG. 17 shows a graphical representation for showing an interrelation between a hinge torque curve of an opening and closing device for opening and closing body according to the invention and a moment curve of the opening and closing body.

### EMBODIMENTS

In the following, a preferable embodiment of the invention as used for a cabinet for furniture, etc. is described; however, as stated above, an opening and closing device for opening and closing body according to the invention is not limited to the cabinet for furniture, etc., but also applicable to opened and closed bodies such as cabinets of other devices of various sorts and others (e.g. copying machine, (multifunction) printer, etc.), as attached to such opened and closed bodies.

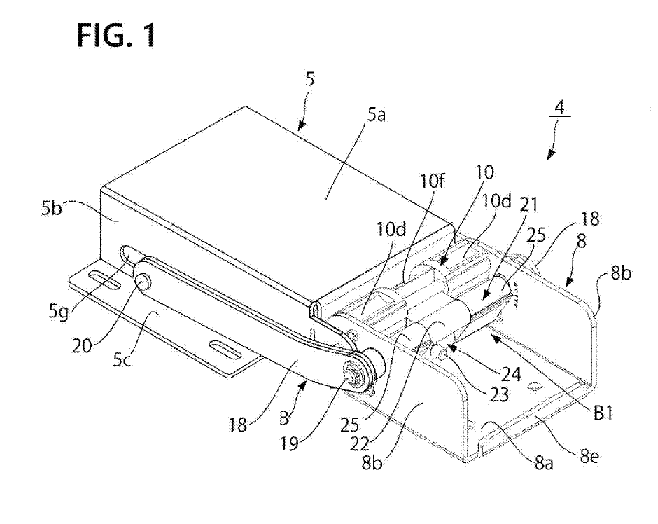

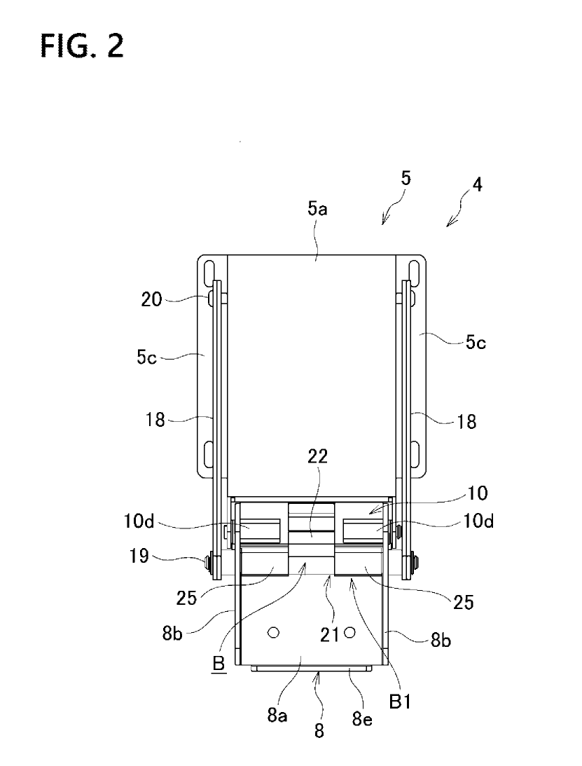

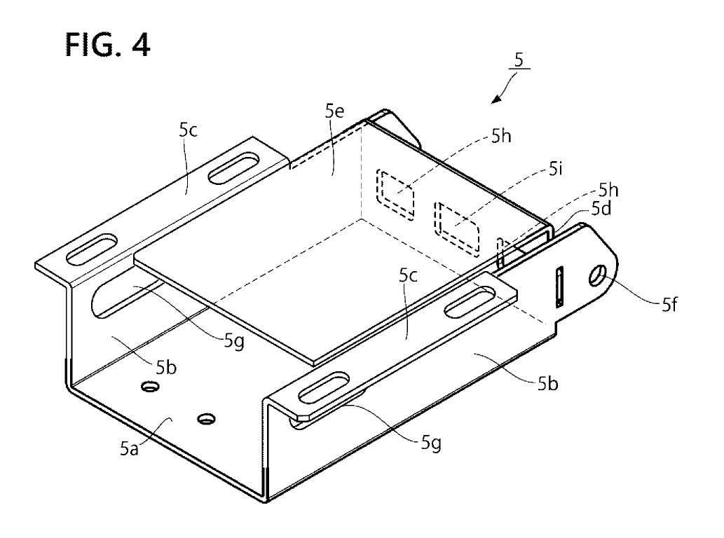

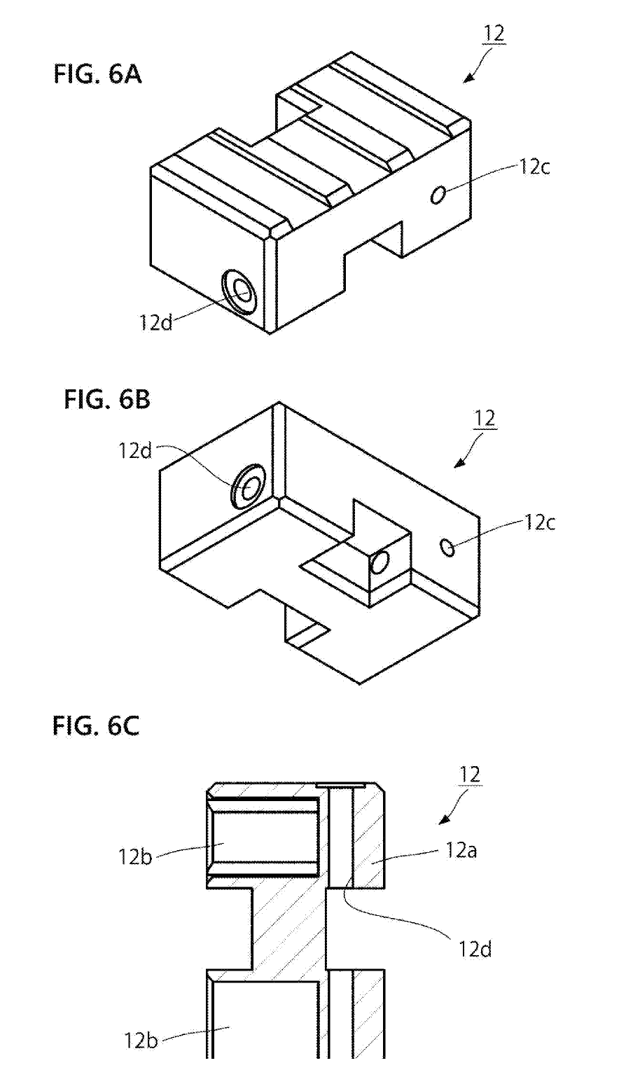

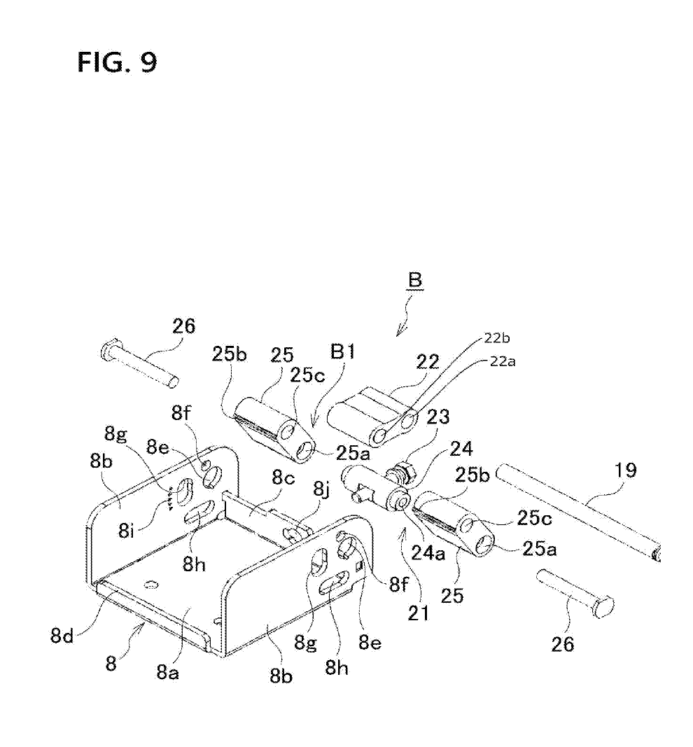

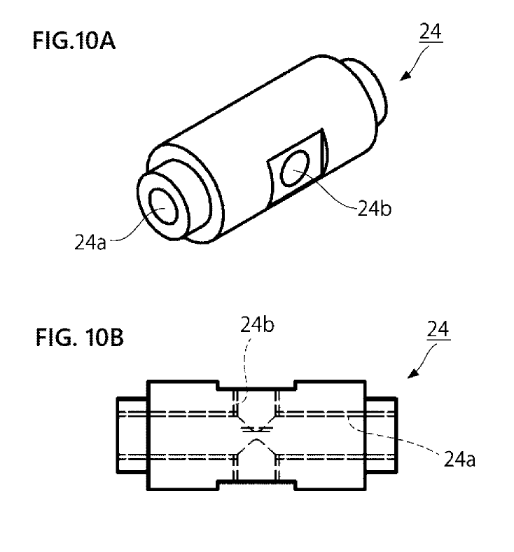

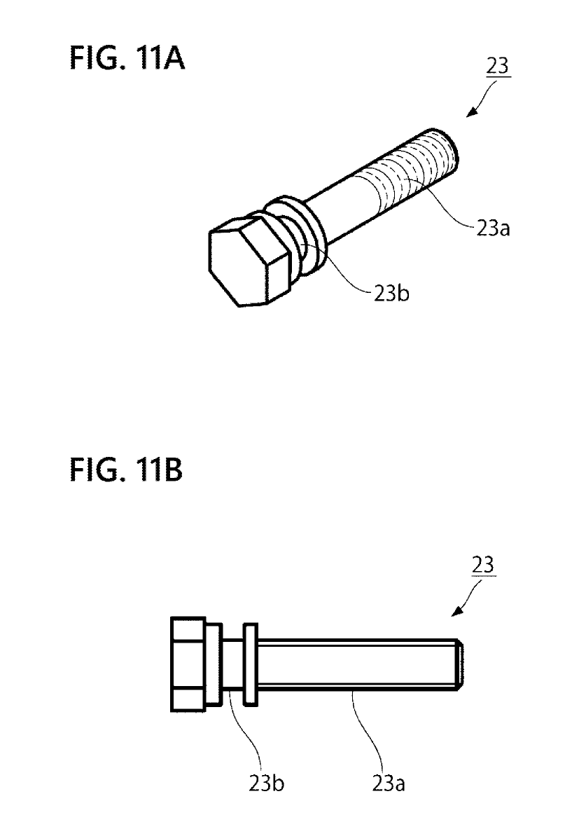

FIGS. 1 to 11 show an embodiment of an opening and closing device 4 for opening and closing body according to the invention. According to the drawings, an opening and closing device 4 for opening and closing body according to the invention comprises an attaching member 5 attached to a cabinet main body (not shown; being opened and closed body), an opening and closing member 8 rotatably attached to the attaching member 5 via a hinge shaft 9, a rotation member 10 through which the hinge shaft 9 passes, so that it is provided so as to be rotatable together with the opening and closing member 8, a rotation torque controlling means A of the opening and closing member 8 provided in the attaching member 5 in contact with the rotation member 10, and a torque peak adjusting means B predominantly provided on the opening and closing member 8 side.

An attaching member 5 according to the embodiment is made up by pressing a metal plate such as SUS; it comprises a back plate 5a, both side plates 5b, 5b bent from the back plate 5a, attaching plates 5c, 5c bent outward from the both side plates 5b, 5b, a front plate 5d bent downward from the back plate 5a, and a bottom plate 5e bent to the rear from the front plate 5d; first hinge shaft coupling holes 5f, 5f are provided to the front on the both side plates 5b, 5b, while guide oblong holes 5g, 5g for passing a second link arm are provided to the rear; the attaching member is therefore attached to a main body of an opened and closed body, etc. via attaching screws not shown.

An opening and closing member 8 according to the embodiment is also made up by pressing a metal plate such as SUS; it comprises an attaching plate 8a, both side plates 8b, 8b erected from the attaching plate 8a, and in addition, a rear plate 8c bent upward from a rear end portion side of the attaching plate 8a, a front plate 8d erected from a front side of the attaching plate 8a; second hinge shaft coupling holes 8e, 8e for passing a hinge shaft 9 on rear end portion sides to couple it to both side plates 5b, 5b of an attaching member 5 are provided on respective rear end portion sides of the both side plates 8b, 8b. Close to these second hinge shaft coupling holes 8e, 8e, attaching holes 8f, 8f for passing a first fixing pin 9a for fixing a rotation member 10 are provided, and adjacent to these attaching holes 8f, 8f, guide long holes 8g, 8g for passing a first link shaft 19 of a torque adjusting means B to be described below in upward and downward direction are provided. Under both side plates 8b, 8b, guide oblong holes 8h, 8h also for a first link member 21 of a torque adjusting means B are provided. Still further, angle marks 8i, 8i (which can be also scales) for adjusting torque peak angles are provided inside guide oblong holes 8g, 8g provided on both side plates 8b, 8b of an opening and closing member 8; the opening and closing member is structured so as to be rotatably coupled to an attaching member 5 by a hinge shaft 9 made of a metal such as SUS passing through first hinge shaft coupling holes 5f, 5f of the attaching member 5 as well as through second hinge shaft coupling holes 8e, 8e, wherein its attaching plate 8a is attached to an opened and closed body, such as the one not shown herein.

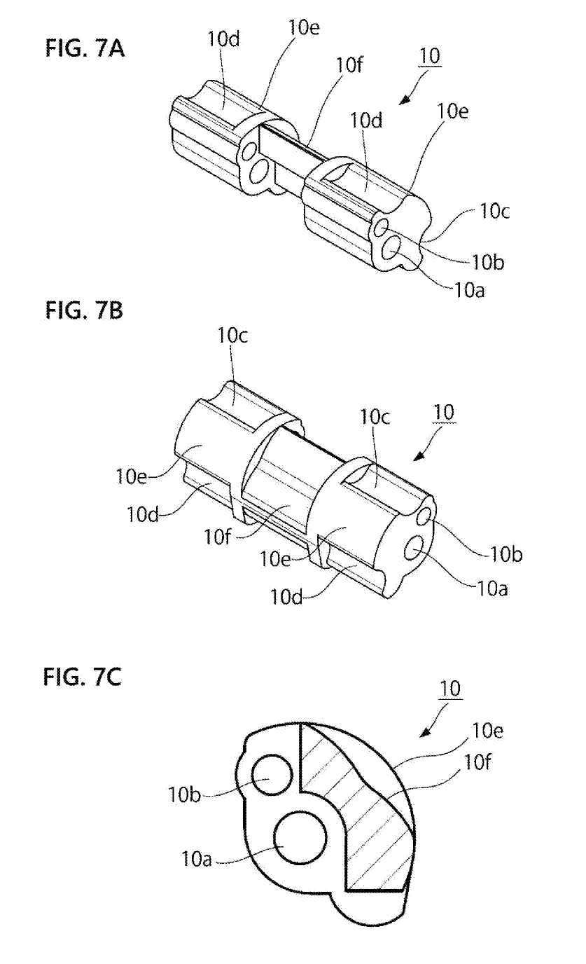

A rotation member 10 in the embodiment is made of synthetic resin such as POM, and structured, in particular as shown in FIG. 7, to rotate together with an opening and closing member 8, with a hinge shaft 9 as a fulcrum, by inserting the hinge shaft 9 into a hinge shaft attaching hole 10a provided as passing through in its axial direction and by passing a fixing pin 9a through a fixing hole 10b provided on its upper portion side. On the rotation member 10, first locking concave portions 10c, 10c are provided on a lower portion side on an outer circumference on their both end portions; second locking concave portions 10d, 10d are formed on its upper portion side, each of first cam portions 10e, 10e are formed between each of the first locking concave portions 10c, 10c and each of the second locking concave portions 10d, 10d, and a second cam portion 10f for a fluid damper 16, on its central portion.

Next, it is recommended to attach a cover member on the outside of an attaching member 5. This cover member can be also attached on the outside of an opening and closing member 8. Still further, expressions that both side plates, an attaching plate, a front plate, a rear plate, etc. are “bent” are used, however, in the embodiment as follows, if an attaching member 5, an opening and closing member 8, etc. are made of synthetic resin, there is no need for special efforts to bend these elements, but these can be just integrally formed from the beginning.

Next, reference is made to a rotation torque controlling means A of an opening and closing member 8. In the embodiment, it comprises a rotation member 10 provided on the opening and closing member 8 side, a spring holder 11 and a slider 12, wherein both are housed inside an attaching member 5, main elastic members 13, 13 resiliently provided between the spring holder 11 and the slider 12, locking members 15, 15 provided between the attaching member 5 and the rotation member 10 via sub-elastic members 14, 14; still further, in the embodiment, the rotation torque controlling means A comprises a locking means A1 for locking the opening and closing member 8 at a predetermined opening and closing angle, a rotation torque adjusting means A2 for adjusting a rotation torque of the opening and closing member 8 and a buffering means A3.

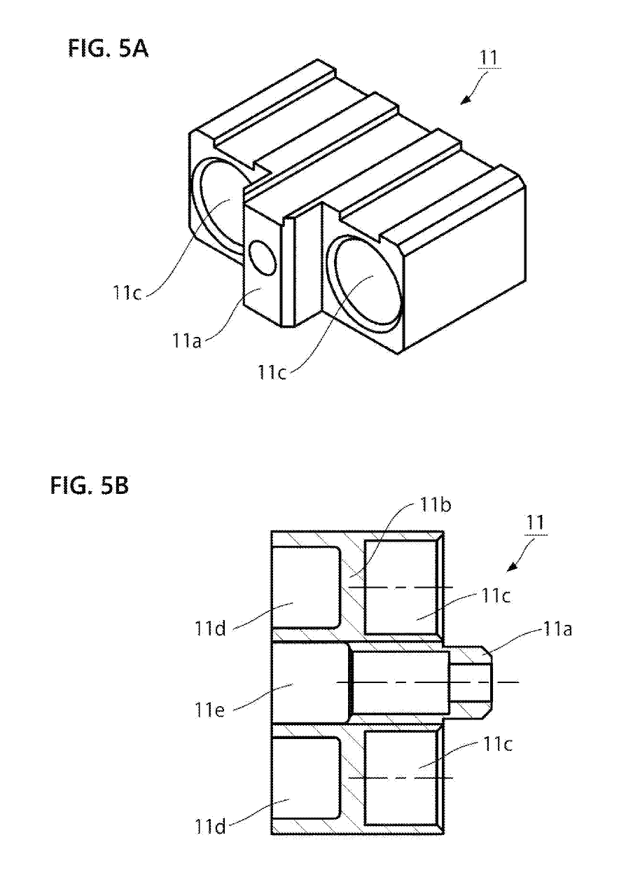

In particular as shown in FIG. 5, a spring holder 11 is housed inside an attaching member 5 on its front plate 5d side, and surrounded by a back plate 5a, both side plates 5b, 5b and a bottom plate 5e of the attaching member 5. Still further, in the spring holder 11, a convex portion 11a is provided on its one end portion side, as well as a partition wall 11b substantially on its central portion; a pair of first spring housing holes 11c, 11c are further formed on a slider 12 side, as well as a pair of locking member housing holes 11d, 11d on a side of a front plate 5d of a spring case 5 are formed as separated by the partition wall 11b, with their respective ends being opened; furthermore, a damper housing hole 11e is provided on its central portion, without being separated by the partition wall 11b, with its end being opened on a side of a front plate 5d of an attaching member 5.

A slider 12 is slidably housed inside an attaching member 5 as opposed to a spring holder 11, and a pair of second spring housing holes 12b, 12b, respectively with a bottom portion 12a, are provided on it. On the slider 12, a screw inserting hole 12c for inserting an adjusting screw 17 through one of the second spring housing holes 12b in its slide direction is provided on its bottom portion 12a, and an insertion hole 12d for a second link shaft 20 is provided perpendicular to the slide direction. Main elastic members 13, 13 are both compression springs, and housed into each of first spring housing holes 11c, 11c of a spring holder 11 and each of second spring housing holes 12b, 12b of a slider 12.

Each of locking members 15, 15 is housed into each of locking member housing holes 11d, 11d of a spring holder 11, together with each of sub-elastic members 14, 14, both consisting e.g. of compression coil springs; after assembly, each of its convex portions 15a, 15a is structured to protrude from each of locking member insertion holes 5h, 5h provided on a front plate 5d of an attaching member 5 to be in pressurized contact with a rotation member 10. A convex portion 16c of a cap 16b placed over a piston rod 16a of a fluid damper 16 protrudes from a piston rod insertion hole 5i provided between locking member insertion holes 5h, 5h on a front plate 5d of an attaching member 5; it is also structured to be in pressurized contact with first cam portions 10e, 10e of the rotation member 10 at the time of assembly. In the meantime, the cap 16b is housed into a damper housing hole 11e provided on the spring holder 11.

A locking means A1 of a rotation torque controlling means A is composed of first locking concave portions 10c, 10c and second locking concave portions 10d, 10d provided at predetermined angular intervals on both end portion sides of a rotation member 10, as well as of locking members 15, 15 attached to a spring holder 11 by sub-elastic members 14, 14 so as to be slidable in one direction, wherein the locking members are fit into the first locking concave portions 10c, 10c and the second locking concave portions 10d, 10d at predetermined opening and closing angles of an opening and closing member 8.

Next, each of rotation torque adjusting means A2 of a rotation torque controlling means A is composed of an adjusting screw 17 provided on a side in which one main elastic member 13 is housed of a slider 12 toward one first spring housing hole 11c, a fixing plate 17a screwed onto the adjusting screw 17 within one second spring housing hole 12b, and a receiving seat portion 17b for receiving one end portion side of the main elastic member 13.

Then, a buffering means A3 of a rotation torque controlling means A is composed of a fluid damper 16 and a second cam portion 10f directed to a rotation member 10, it is structured to allow a convex portion 16c of a cap 16b as mentioned above to be in pressurized contact with the second cam portion 10f, starting from a predetermined angle of an opening and closing member 8.

In a description in the foregoing, a rotation torque controlling means A comprises a rotation member 10, a spring holder 11, a slider 12, locking members 15, 15 slidably urged by sub-elastic members 14, 14 and thus housed in the spring holder 11, and main elastic members 13, 13 resiliently provided between the spring holder 11 and the slider 12; still further, it comprises a locking means A1, rotation torque adjusting means A2 and a buffering means A3; however, all these components are optional, and without these, a rotation torque of an opening and closing member can be adjusted. In the simplest manner, it can be structured to comprise merely a rotation member 10 and a slider of a known structure (not shown) slidably urged by elastic members toward the rotation member 10 inside an attaching member 5. The invention meets requirements for novelty only by a combination of a rotation torque controlling means A and a torque peak adjusting means B in this simplest structure.

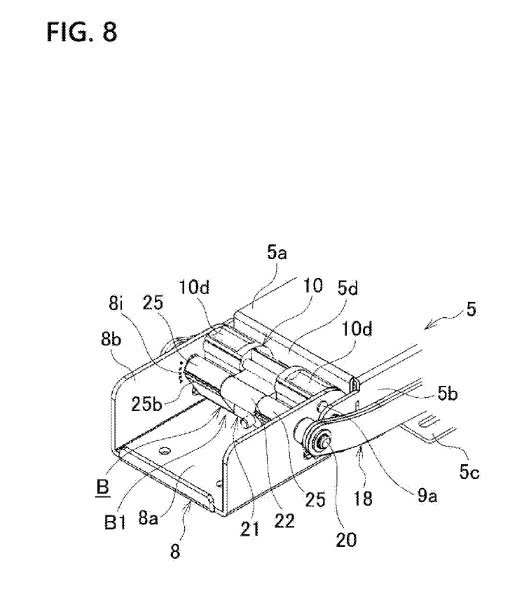

Next, reference is made to a torque peak adjusting means B. Especially as shown in FIGS. 8, 9 and 16, the torque peak adjusting means B comprises a first link member 21, wherein its one end portion arranged between both side plates 8b, 8b of an opening and closing member 8 is attached to the opening and closing member 8 so as to be slidable in a back and forth direction, and its other end portion is coupled to a first link shaft 19, a second link member 22, wherein its one end portion is coupled to a hinge shaft 9, and its other end portion is coupled to a first link shaft 19, and a position adjusting means B1 for driving the first link member 21 to swing a second link shaft 20.

In the embodiment, a position adjusting means B1 comprises a first link member 21, wherein both side portions on its one end portion side are coupled to slide pins 26, 26, and its other end portion is coupled to a first link shaft 19, a second link member 22, wherein a coupling hole 22a on its one end portion is coupled to a hinge shaft 9, and a coupling hole 22b on its other end portion is coupled to a first link shaft 19, and an adjusting member 23 rotatably attached to a screw attaching hole 8j provided on a rear plate 8c of an opening and closing member 8, wherein its male screw portion is screwed with the first link member 21. The first link member 21 comprises a first member 24, wherein coupling holes 24a are provided on its both end portions in an axial direction, and a female screw hole into which a male screw portion 23a of the adjusting member 23 is screwed, and a pair of second members 25, 25 arranged on both sides of the first member 24 and comprising through holes 25a, 25b; 25a, 25b arranged on the side of both side plates 8b, 8b of an opening and closing member 8 to pass through at an upper and lower positions in an axial direction; slide pins 26, 26 are attached so as to be slidable in back and forth direction relative to guide oblong holes 8h, 8h provided on both side plates 8b, 8b of the opening and closing member 8, to pass through through holes 25a, 25a provided on the second members 25, 25, so that the slide pins are inserted into the coupling hole 24a of the first member 24. In the embodiment, a screw attaching hole 8j provided on a rear plate 8c has a gourd shape by a combination of a small diameter portion and a large diameter portion, a neck portion 23b for engaging with the small diameter portion is provided on an adjusting member 23. In the meantime, the first member 24 and the second members 25, 25 can be also integrally formed in the first link member 21. Moreover, as per each of the second members 25, 25, a first link shaft passes through its through holes 25b, 25b, and pointed projection portions 25c, 25c are provided along with its axial direction and designed to point angle marks 8i, 8i provided on both side plates 8b, 8b.

Here, a hinge shaft 9, a first link shaft 19, a second hinge shaft 20, slide pins 26, 26, etc. comprise respective flange portions on their respective one end portions, through these are not shown well. The hinge shaft 9, the first link shaft 19, the second hinge shaft 20, a fixing pin 9a, etc. have their respective other end portion sides caulked, so as not to escape from their respective coupling positions in an axial direction. Otherwise, E-rings can be also used.

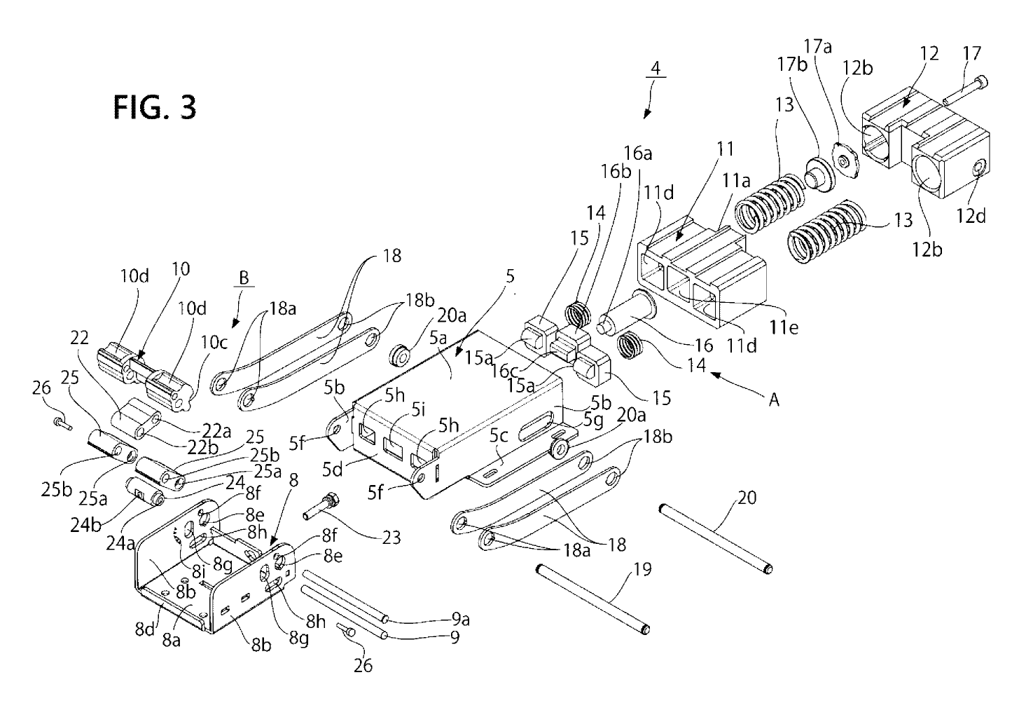

In particular as shown in FIG. 3, each of link arms 18, 18 is composed of a pair of two belt-shaped objects, one overlapping another; it is arranged outside both side plates 5b, 5b of an attaching member 5; first coupling holes 18a, 18a provided on its one end portion are rotatably coupled to respective end portions of a first link shaft 19, and second coupling holes 18b, 18b provided on its other end portion are rotatably coupled to respective end portions of a second link shaft 20.

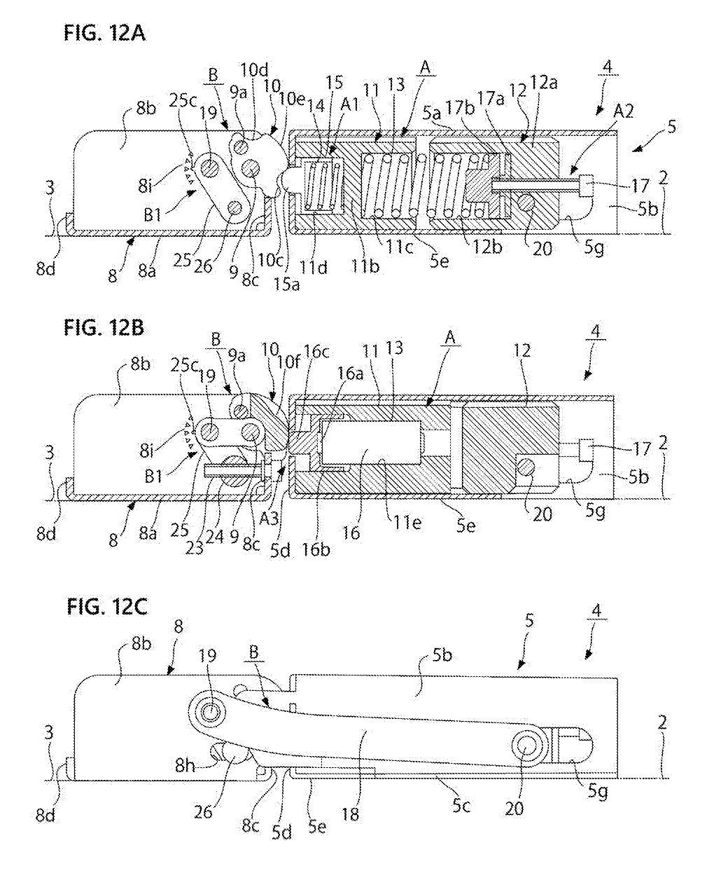

Next, reference is made to the operation and effect of the opening and closing device for opening and closing body 4 according to the invention, and first in particular to the rotation torque controlling means A, with reference to FIGS. 12 to 15. FIG. 12 shows the state of the opening and closing angle of 0 degree, in which the opening and closing body 3 is closed relative to the opened and closed body 2; in the state of the opening and closing angle of 0 degree, the main elastic members 13, 13 are pushed and compressed by the slider 12 pulled by the link arms 18, 18 toward the spring holder 11 side via the second link shaft 20, and the convex portions 15a, 15a of the locking members 15, 15 fall into the first locking concave portions 10c, 10c of the rotation member 10. Furthermore, the sub-elastic members 14, 14 pressurize the locking members 15, 15 toward the first locking concave portions 10c, 10c of the rotation member 10, so that the opening and closing body 3 is locked at this closing state and stably maintains the closing state. Still further, the convex portion 16c of the cap 16b attached to the piston rod 16a of the fluid damper 16, which protrudes from the piston rod insertion hole 5i provided on the front plate 5d of the attaching member 5, is in pressurized contact with the second cam portion 10f provided on the outer circumference of the rotation member 10.

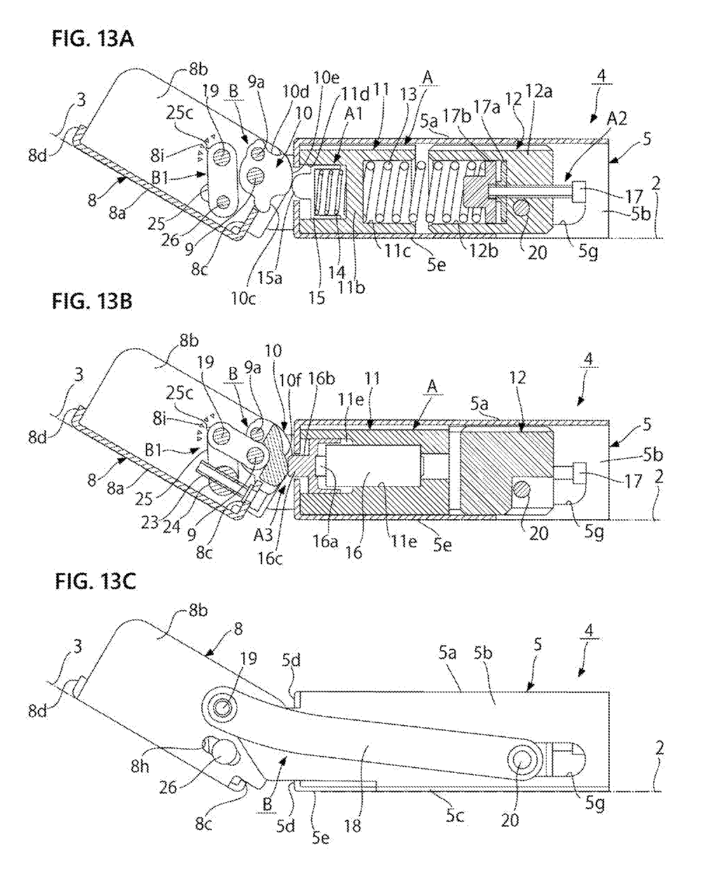

FIG. 13 shows the state of the opening and closing body 3 opened 30 degrees from the state of the opening and closing angle of 0 degree, as shown in FIG. 12. In this state, the opening and closing member 8 rotates clockwise, and the convex portions 15a, 15a of the locking members 15, 15 are released from the first locking concave portions 10c, 10c of the rotation member 10, being in pressurized contact with the first cam portions 10e, 10e on the outer circumference of the rotation member 10, and the opening and closing member 8 is urged to rotate upward in the opening direction, so that the opening and closing body 3 can be smoothly opened without giving a feel of its own weight.

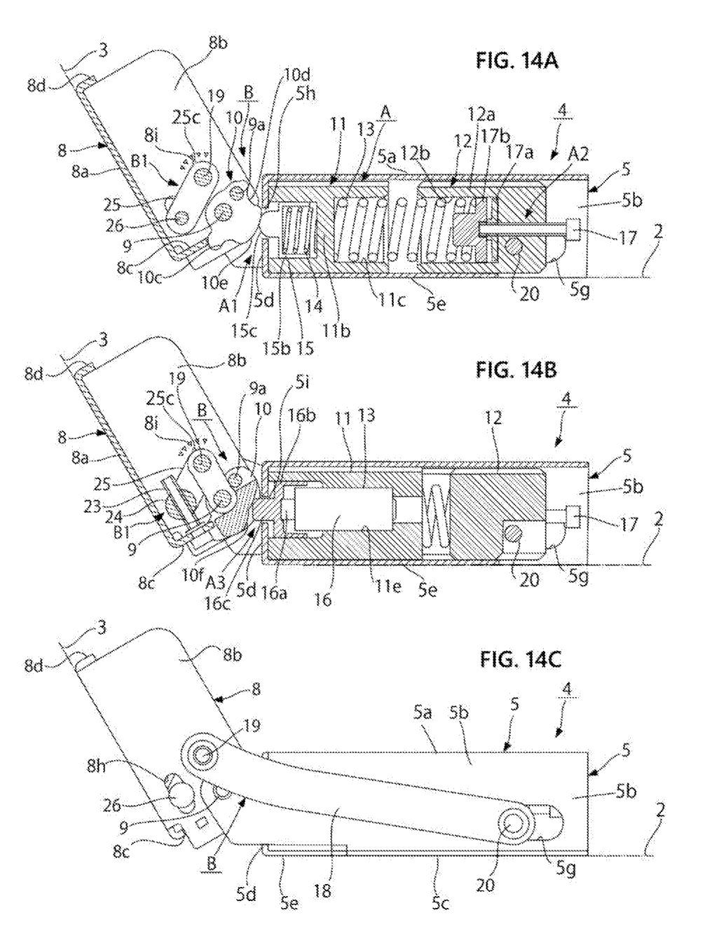

FIG. 14 shows the state of the opening and closing body 3 opened 60 degrees from the state shown in FIG. 12; in this state, the opening and closing body 3 is in pressurized contact with the first cam portions 10e, 10e of the rotation member 10, so that it can maintain the opening angle of 60 degrees, without automatically falling.

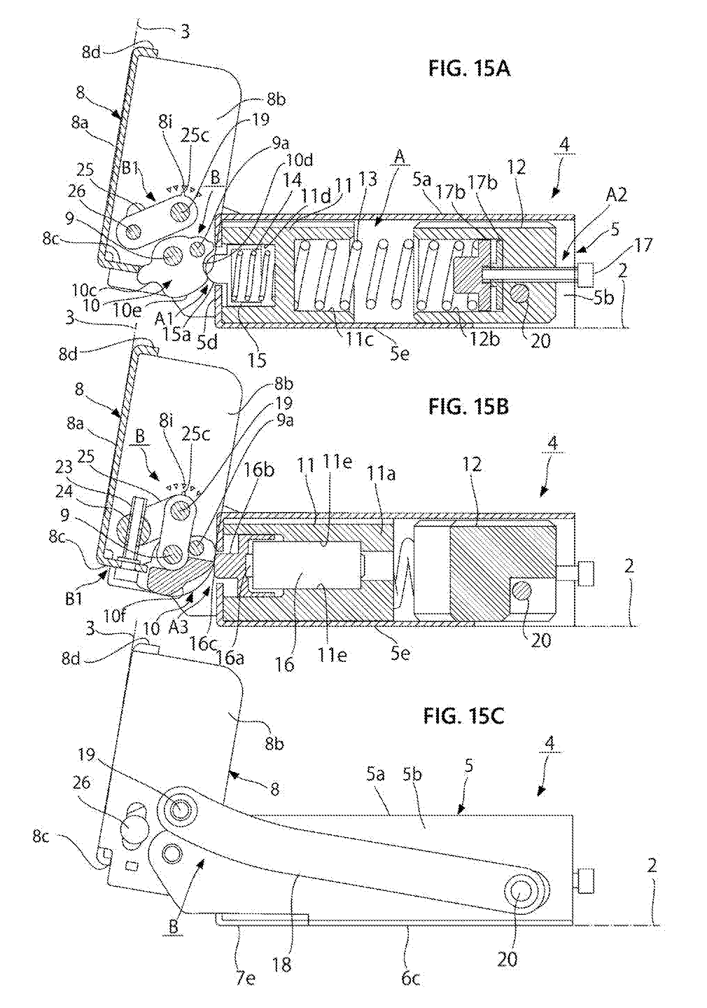

FIG. 15 shows the state of the opening and closing body 3 opened 100 degrees from the state shown in FIG. 12; at this opening angle of 100 degrees, the convex portions 15a, 15a of the locking members 15, 15 fall into the second locking concave portions 10d, 10d of the rotation member 10, and the sub-elastic members 14, 14 pressurize the convex portions 15a, 15a of the locking members 15, 15 into the second locking concave portions 10d, 10d, so that the opening and closing body 3 is stably held at this opening angle of 100 degrees and does not easily fall to close, even in case of vibration or shaking of the opened and closed body 2.

Next, when the opening and closing body 3 once opened up is closed, the convex portions 15a, 15a of the locking members 15, 15 are released from the second locking concave portions 10d, 10d of the rotation member 10, and the opening and closing member 8 rotates counterclockwise as is shown in the drawings, in pressurized contact with the first cam portions 10e, 10e of the rotation member 10, so that the opening and closing body 3 is closed. Once the opening and closing body 3 reaches the predetermined closing angle, the second cam portion 10f of the rotation member 10 is in pressurized contact with the convex portion 16c of the cap 16b of the fluid damper 16, which thus prevents the opening and closing body 3 from suddenly falling, so that it is calmly closed.

As shown in FIG. 12, in the closed opening and closing body 3, the convex portions 15a, 15a of the locking members 15, 15 fall into the first locking concave portions 10c, 10c of the rotation member 10, so that the opening and closing body 3 stably maintains its closed state.

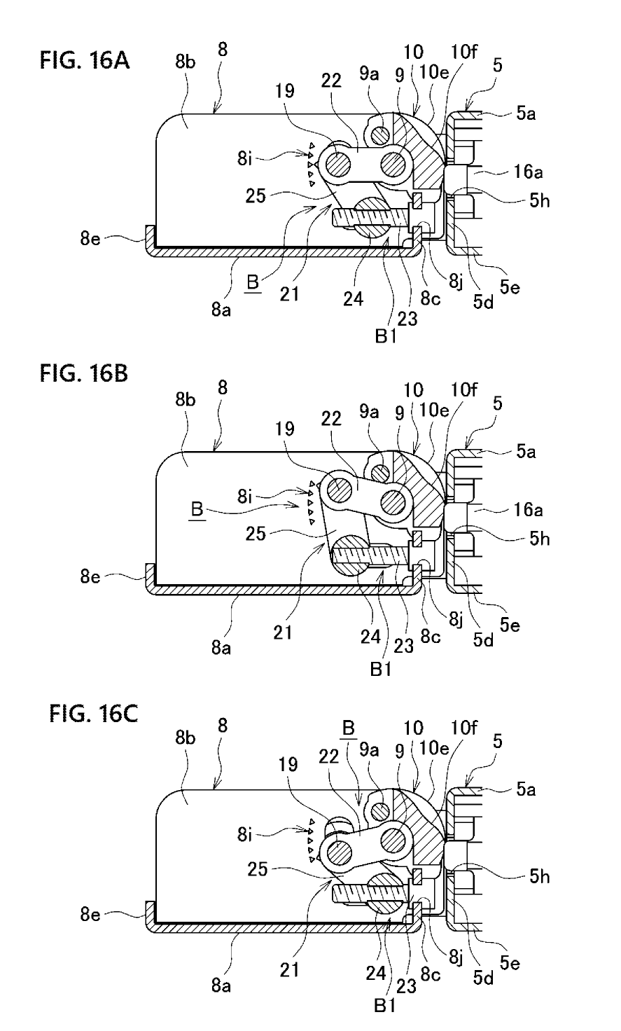

Next, the torque peak of the opening and closing body 3 is adjusted by the torque peak adjusting means B, through the rotation of the adjusting member 23 either to the right or left. Namely, as shown in FIG. 16, the pointed projection portions 25c, 25c of the second members 25, 25 point the one in the middle among the angle marks 8i, 8i at the opening and closing angle of 0 of the opening and closing member 8, thus in the closed state of the opening and closing body 3. When the adjusting member 23 is rotated from this state either to the right or left, the first member 24 of the first link member 21 is guided by the slide pins 26, 26 to slide in back and forth direction of the opening and closing member 8 relative to the opening and closing member. Then, the first link shaft 19 is guided through the second members 25, 25 inside the guide long holes 8g, 8g provided on the both side plates 8b, 8b of the opening and closing member 8 to rotate in upward and downward direction, with the second link shaft 20 as a fulcrum. Thereupon, the position of starting the opening operation of the opening and closing body 3 from its opening angle of 0 degree via the opening and closing member 8 is shifted; here, provided that the torque peak for the hinge torque of the opening and closing device for opening and closing body 4 is set at the torque peak of 60 degrees when the pointed projection portions point 0 degree, i.e. the one in the middle among the angle marks 8i, 8i, when the first link shaft 19 lies below the guide long holes 8g, 8g of the opening and closing member 8, the torque peak is shifted upward as compared to the reference situation. When the first link shaft 19 lies above the guide long holes 8g, 8g, the torque peak is shifted downward as compared to the reference situation.

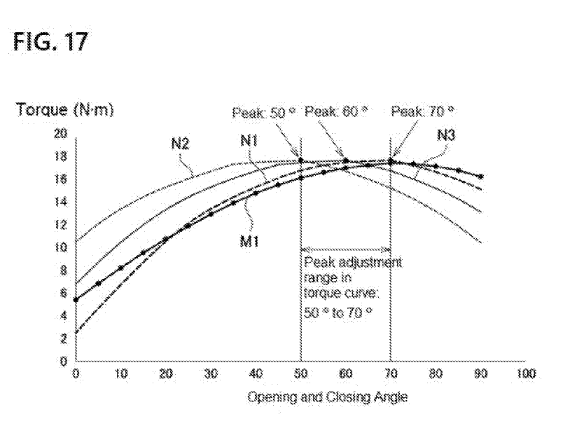

The embodiment is structured such that, if the torque peak defaults to 60 degrees, as shown in FIG. 16, the torque peak can be adjusted between 50 degrees, i.e. −10 degrees and 70 degrees, i.e. +10 degrees. According to FIG. 17, the curve denoted with M1 herein represents the moment curve for the opening and closing body 3, while the one denoted with N1 represents the reference torque curve for the opening and closing device for opening and closing body 4. According to the drawing, the torque peak in this case is 60 degrees. The curve N2 represents the case that the first link shaft 19 lies below the guide long holes 8g, 8g of the opening and closing member 8, and in this case, the torque peak is 50 degrees; the curve N3 represents the torque curve, where the first link shaft 19 lies above the guide long holes 8g, 8g of the opening and closing member 8, and in this case, the torque peak is 70 degrees. In this manner, the torque peak for the opening and closing device for opening and closing body 4 according to the invention can be adjusted between 50 degrees and 70 degrees.

Next, reference is made to the operation of the locking means A1. The locking means A1 is composed of the first locking concave portions 10c, 10c and the second locking concave portions 10d, 10d provided on the rotation member 10, as well as of the locking members 15, 15 and the sub-elastic members 14, 14 slidably provided in the spring holder 11; in the embodiment, the convex portions 15a, 15a of the locking members 15, 15 respectively protruding from the locking member insertion holes 5h, 5h are fitted into the first locking concave portions 10c, 10c at the opening and closing angle of 0 degree of the opening and closing member 8, and the opening and closing member 8 is locked at its opening and closing angle of 0 degree; furthermore, the convex portions 15a, 15a of the locking members 15, 15 are fitted into and locked to the second locking concave portions 10d, 10d at the opening and closing angle of 100 degrees, and stably held at the opening and closing angle of 100 degrees. In the meantime, the installation positions and the number of the first locking concave portions 10c, 10c and the second locking concave portions 10d, 10d are not limited to those in the Embodiment. They can be modified, or increased or decreased, as is necessary.

Next, reference is made to the operation of the rotation torque adjusting means A2; the adjusting screw 17 provided on a side of one main elastic member 13 is rotated either to the right or left, so that the receiving seat portion 17b is shifted in the axial direction of the adjusting screw 17; in this manner, the elastic force of the main elastic member 13 fluctuates, so that the rotation torque of the opening and closing member 8 can be adjusted.

The buffering means A3 consists of the fluid damper 16; when the opening and closing body 3 is closed and the opening and closing member 8 reaches the predetermined closing angle from the opened state, the convex portion 16c of the cap 16b protruding from a piston rod insertion hole 5i provided on the front plate 5d of the attaching member 5 is in pressurized contact with the second cam portion 10f provided on the rotation member 10, so that the brake is applied and the opening and closing body 3 attached to the opening and closing member 8 is calmly closed, without suddenly closing.

Other embodiments may include, though not shown, the one with a hinge shaft separated into two being respectively coupled to each of both side plates 8b, 8b on the opening and closing member 8 side and to each of both side plates 5b, 5b of the attaching member 5.

Since the invention is constructed as described in the foregoing, an opening and closing device for opening and closing body according to the invention is in particular used to openably and closably attach the opening and closing body to an opened and closed body such as a piece of furniture, so that it allows the opening and closing body to open and close without giving a feel of its own weight, to maintain a predetermined intermediate opening angle and to stably hold its stop at a fully closed and a fully opened state. Furthermore, it is suitably used as an opening and closing device for opening and closing body for allowing for a buffering function of preventing the opening and closing body from suddenly closing during a closing operation, thus enabling an adjustment of a torque peak and a rotation torque, and also as various opened and closed bodies using such an opening and closing device for opening and closing body.

1. An opening and closing device for opening and closing body provided between said opening and closing body and an opened and closed body for openably and closably coupling said opening and closing body to said opened and closed body, said opening and closing device comprising:
an attaching member having at least a back plate and both side plates provided from said back plate, said attaching member being attached to said opened and closed body;
an opening and closing member having at least an attaching plate to which the opening and closing body is attached and both side plates provided from said attaching plate, said opening and closing member being rotatably attached to said attaching member via a hinge shaft;
a rotation torque controlling means for controlling a rotation torque of said opening and closing member;
a torque peak adjusting means for adjusting a torque peak of said opening and closing member at the time of opening and closing movement thereof;
said rotation torque controlling means comprising a rotation member attached to said hinge shaft to rotate together with said opening and closing member, and a slider provided on said attaching member side and slidably urged by an elastic member toward said rotation member; and
said torque peak adjusting means comprising a link arm, one end thereof being coupled to a slider side via a second link shaft, and other end thereof being rotatably attached to an opening and closing member side via a first link shaft rotatably attached with a coupling position on said slider side as a fulcrum, and a position adjusting means provided on said opening and closing member side and capable of adjusting a rotation starting position of said link arm.

2. The opening and closing device for opening and closing body according to claim 1, said rotation torque controlling means comprising a locking means capable of locking said opening and closing body at a predetermined opening and closing angle, said locking means comprising a rotation member attached to said hinge shaft so as to be rotatable together with said opening and closing member, and a locking member provided on said attaching member side so as to be slidable to a rotation member side and to engage with concave portions provided on said rotation member at a predetermined rotation angle of said opening and closing member.

3. The opening and closing device for opening and closing body according to claim 1, said rotation torque controlling means comprising on a slider side a rotation torque adjusting means capable of adjusting a rotation torque of said opening and closing member.

4. The opening and closing device for opening and closing body according to claim 1, said rotation torque controlling means comprising a buffering means between a slider and a rotation member, said buffering means being composed of a fluid damper for bringing a tip of a piston rod into a pressurized contact with a second cam portions provided on said rotation member, starting from a predetermined rotation angle of said opening and closing member in a closing direction.

5. The opening and closing device for opening and closing body according to claim 1, said position adjusting means of said torque peak adjusting means comprising a first link member, with one end thereof being attached so as to be slidable in forward and backward direction relative to said opening and closing member and other end thereof being coupled to a first link shaft, a second link member, one end thereof being coupled to said first link shaft and other end thereof being coupled to said hinge shaft, and an adjusting member attached to said opening and closing member and screwed with said first link member.

6. An opened and closed body of different sorts comprising the opening and closing device for opening and closing body according to claim 1.

7. An opened and closed body of different sorts comprising the opening and closing device for opening and closing body according to claim 2.

8. An opened and closed body of different sorts comprising the opening and closing device for opening and closing body according to claim 3.

9. An opened and closed body of different sorts comprising the opening and closing device for opening and closing body according to claim 4.

10. An opened and closed body of different sorts comprising the opening and closing device for opening and closing body according to claim 5.
